(19) United States
(12) Patent Application Publication
(10) Pub. No.: US 2017/0051536 A1
(43) Pub. Date: Feb. 23, 2017

(54) EMERGENCY FIRE ESCAPE DOOR LOCK DEVICE

(71) Applicant: Gianni Industries Inc., Taipei (TW)

(72) Inventor: Chih Chung CHANG, Taipei (TW)

(21) Appl. No.: 14/828,554

(22) Filed: Aug. 18, 2015

(51) Int. Cl. E05B 65/10; E05C 1/14

(52) U.S. Cl. CPC E05B 65/1053; E05C 1/14

(57) ABSTRACT

A fire escape door lock device includes a lock mechanism attached to a door panel and having a dead bolt for selectively locking the door panel to a door frame, a control device is disposed in the door panel and electrically connected to the lock mechanism, a switch is electrically connected to the control device, and a press bar device is attached to the door panel and coupled to the switch for selectively actuating the switch when the press bar device is depressed toward the door panel, and for selectively releasing the lock mechanism with the control device, and arranged for allowing the emergency fire escape door lock device to be selectively actuated or operated either inside or outside the fire escape door.

### BACKGROUND OF THE INVENTION

1. Field of the Invention

The present invention relates to a fire escape door lock device, and more particularly to an emergency fire escape door lock device including an electrical control device for controlling the emergency fire escape door lock device and for allowing the emergency fire escape door lock device to be selectively actuated or operated either inside or outside of the fire escape door.

2. Description of the Prior Art

Various kinds of typical emergency panic exit door or fire escape door lock devices have been developed and provided for controlling the fire escape door, and normally comprise a mechanical structure for controlling or opening or closing the fire escape door.

For example, U.S. Pat. No. 3,614,145 to Zawadzki, U.S. Pat. No. 3,877,262 to Williams, U.S. Pat. No. 4,796,931 to Heid, U.S. Pat. No. 5,219,385 to Yeh, U.S. Pat. No. 6,009,732 to Haecket, and U.S. Pat. No. 6,032,985 to Cutter disclose several of the typical emergency panic exit door or fire escape door lock devices each also comprising a mechanical structure for controlling or opening or closing the fire escape door.

However, normally, the typical emergency panic exit doors or fire escape doors are arranged to be opened or closed or actuated or operated from inside of the fire escape door, but may not be opened or closed or actuated or operated from outside of the fire escape door.

The present invention has arisen to mitigate and/or obviate the afore-described disadvantages of the conventional emergency fire escape door lock devices.

### SUMMARY OF THE INVENTION

The primary objective of the present invention is to provide an emergency fire escape door lock device including an electrical control device for controlling the emergency fire escape door lock device and for allowing the emergency fire escape door lock device to be selectively actuated or operated either inside or outside the fire escape door.

In accordance with one aspect of the invention, there is provided a fire escape door lock device comprising a door panel and a door frame, a lock mechanism attached to the door panel and including a dead bolt extendible out of the door panel for selectively engaging with the door frame and for selectively locking the door panel to the door frame, a control device disposed in the door panel, the lock mechanism being electrically connected to the control device, a first switch disposed in the door panel and electrically connected to the control device, and a press bar device attached to the door panel and coupled to the first switch for selectively actuating the first switch when the press bar device is depressed toward the door panel, and for selectively releasing the lock mechanism with the control device.

The press bar device includes a receptacle attached to the door panel, and a moving cover member slidably engaged onto the receptacle with a coupling device and movable toward the receptacle. The coupling device includes a beam slidably engaged in the receptacle and movable toward the first switch for selectively actuating the first switch when the cover member is moved toward the receptacle.

The coupling device includes a bracket pivotally coupled between the receptacle and the cover member for allowing the cover member to be moved toward the receptacle, and the bracket is pivotally coupled to the beam. The lock mechanism includes an electro-magnetic device electrically connected to the control device for actuating the dead bolt to lock the door panel to the door frame.

The lock mechanism includes a follower pivotally attached to the door panel and disposed close to the dead bolt for selectively moving the dead bolt out of the door panel, an elbow is pivotally attached to the door panel and engaged with the follower, the elbow is located close to the electro-magnetic device for being selectively actuated by the electro-magnetic device to force the follower to move the dead bolt out of the door panel.

The follower is pivotally attached to the door panel with a pivot axle, and the follower includes a free end portion, and the elbow portion includes a groove formed therein for engaging with the free end portion of the follower. The dead bolt includes a tongue pivotally coupled to the dead bolt with a pivot spindle for allowing the tongue to be pivoted relative to the dead bolt. The dead bolt includes a guide pole extended laterally and outwardly therefrom. The receptacle includes a housing disposed beside the receptacle and located close to the door frame, and the housing includes a chamber formed therein for engaging with the lock mechanism.

A fire detector may further be provided and electrically connected to the control device for detecting a fire and for sending a detected signal to the control device and for selectively releasing the lock mechanism. An electric power source may further be provided and electrically connected to the control device for energizing the control device.

An outside card reader may further be provided and electrically connected to the control device for controlling the electro-magnetic device. An inside card reader may further be provided and electrically connected to the control device for controlling the electro-magnetic device.

A second switch may further be provided and electrically connected to the control device, a safety pin slidably attached to the door panel and disposed close to the second switch for selectively engaging with the door frame and for being selectively depressed and moved by the door frame to depress and actuate the second switch.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of an emergency fire escape door lock device in accordance with the present invention;

FIG. 2 is another plan schematic view similar to FIG. 1, illustrating the operation of the emergency fire escape door lock device;

FIG. 3 is a partial exploded view of the emergency fire escape door lock device;

FIG. 4 is another partial exploded view of the emergency fire escape door lock device;

FIG. 5 is an enlarged partial perspective view of the emergency fire escape door lock device;

FIG. 6 is another enlarged partial perspective view similar to FIG. 5, illustrating the operation of the emergency fire escape door lock device;

FIG. 7 is a further enlarged partial perspective view of the emergency fire escape door lock device, in which a portion of the outer housing has been cut off for showing the inner structure of the emergency fire escape door lock device;

FIG. 8 is a still further enlarged partial perspective view of the emergency fire escape door lock device;

FIG. 9 is a still further enlarged partial perspective view similar to FIG. 8, illustrating the operation of the emergency fire escape door lock device;

FIG. 10 is a further partial exploded view of the emergency fire escape door lock device;

FIG. 11 is a partial front plan schematic view of the fire escape door lock device;

FIG. 12 is a partial top plan schematic view of the fire escape door lock device; and

FIGS. 13, 14, 15 are plan schematic views similar to FIGS. 1 and 2, illustrating the operation of the fire escape door lock device.

### DETAILED DESCRIPTION OF THE PREFERRED EMBODIMENT

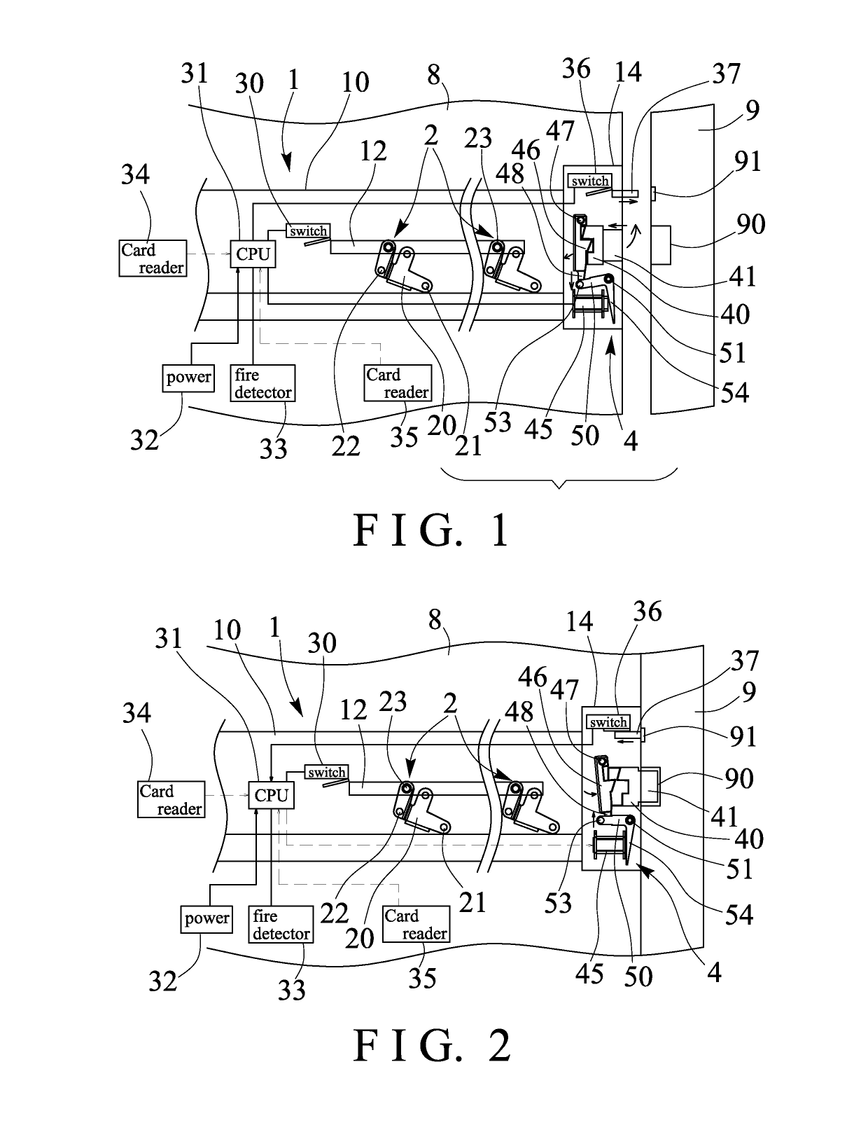

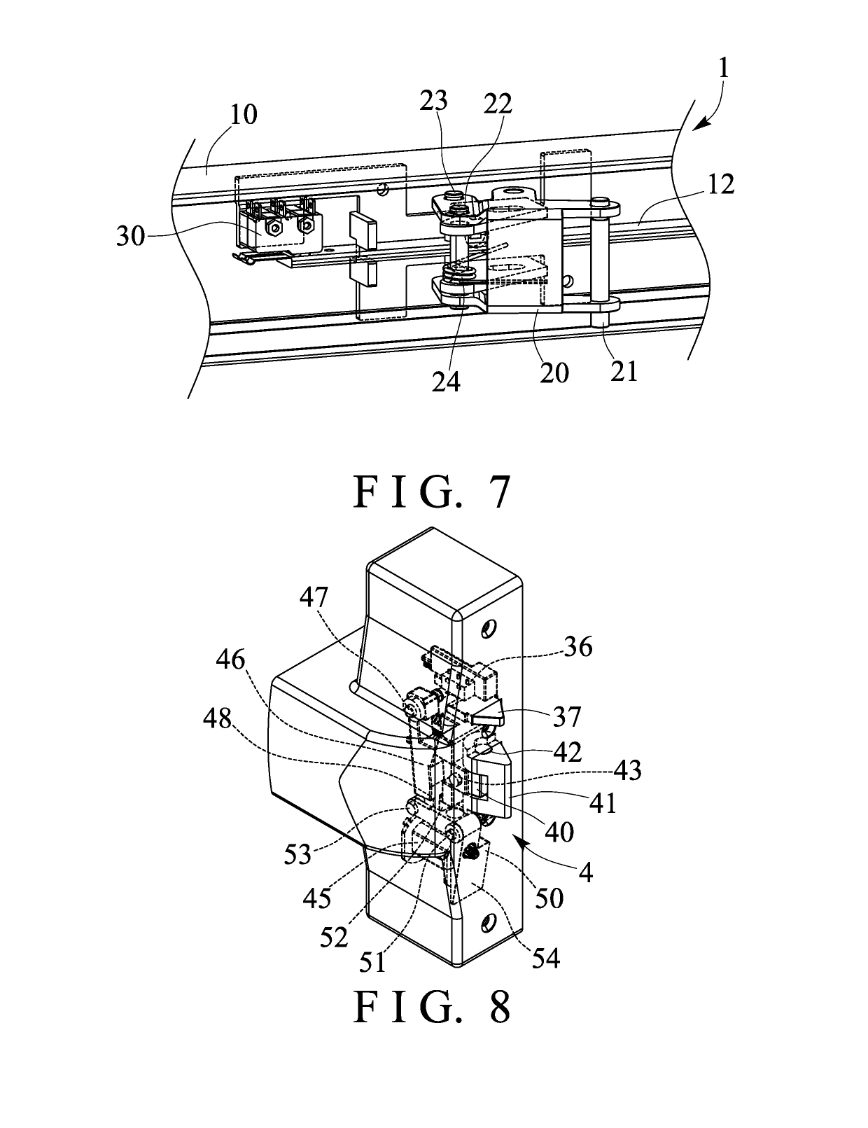

Referring to the drawings, and initially to FIGS. 1 and 2, an emergency fire escape door lock device in accordance with the present invention comprises a press bar device 1 to be attached or mounted or secured to a door panel 8 for locking or releasing the door panel 8 from a door frame 9 or the like. As shown in FIGS. 1-7, the press bar device 1 includes a container or receptacle 10 attached or mounted or secured to the door panel 8, such as the middle or intermediate portion of the door panel 8, and a moving cover member 11 slidably or movably attached or mounted or engaged onto and connected or coupled to the receptacle 10 with a linking or coupling device 2, and slidable or movable or depressible onto or toward the receptacle 10 by the user, for example. A longitudinal lever or beam 12 is slidably or movably received or engaged in the receptacle 10 or in the door panel 8.

For example, the coupling device 2 includes one or more (such as two) levers or brackets 20 each pivotally or rotatably attached or mounted or coupled to the cover member 11 with a pivot pin 21, and each pivotally or rotatably attached or mounted or coupled to the receptacle 10 with a pivot rod 22 for allowing the cover member 11 to be moved or depressed onto or toward the receptacle 10, and the brackets 20 are each pivotally or rotatably attached or mounted or coupled to the longitudinal beam 12 with a pivot shaft 23 for allowing the longitudinal beam 12 to be selectively slid or moved relative to the receptacle 10 by or with the brackets 20 when the cover member 11 is moved or depressed onto or toward the receptacle 10. As shown in FIGS. 4-7, a spring biasing member 24 is disposed or engaged between the receptacle 10 and the bracket 20 for biasing and forcing or moving the cover member 11 away from the receptacle 10.

A switch 30, such as a first or limit switch 30 is disposed or mounted in the receptacle 10 or in the door panel 8 and disposed and arranged or located close to or beside the beam 12 for being selectively depressed or actuated or operated by the beam 12. A logic control module or central processing unit (CPU) or control device 31 is also disposed or mounted in the receptacle 10 and the door panel 8 and electrically connected or coupled to the switch 30 for receiving the control signals from the switch 30, and an electric power source 32 is electrically connected or coupled to the control device 31 for energizing the control device 31, a flame or fire sensor or detector 33 is electrically connected or coupled to the control device 31 for sensing or detecting the flame or fire and for sending or transmitting the detected signals to the control device 31, and one or more (such as two) readers 34, 35, such as card readers 34, 35 are selectively or optionally and electrically connected or coupled to the control device 31 for sending or transmitting the read signals to the control device 31.

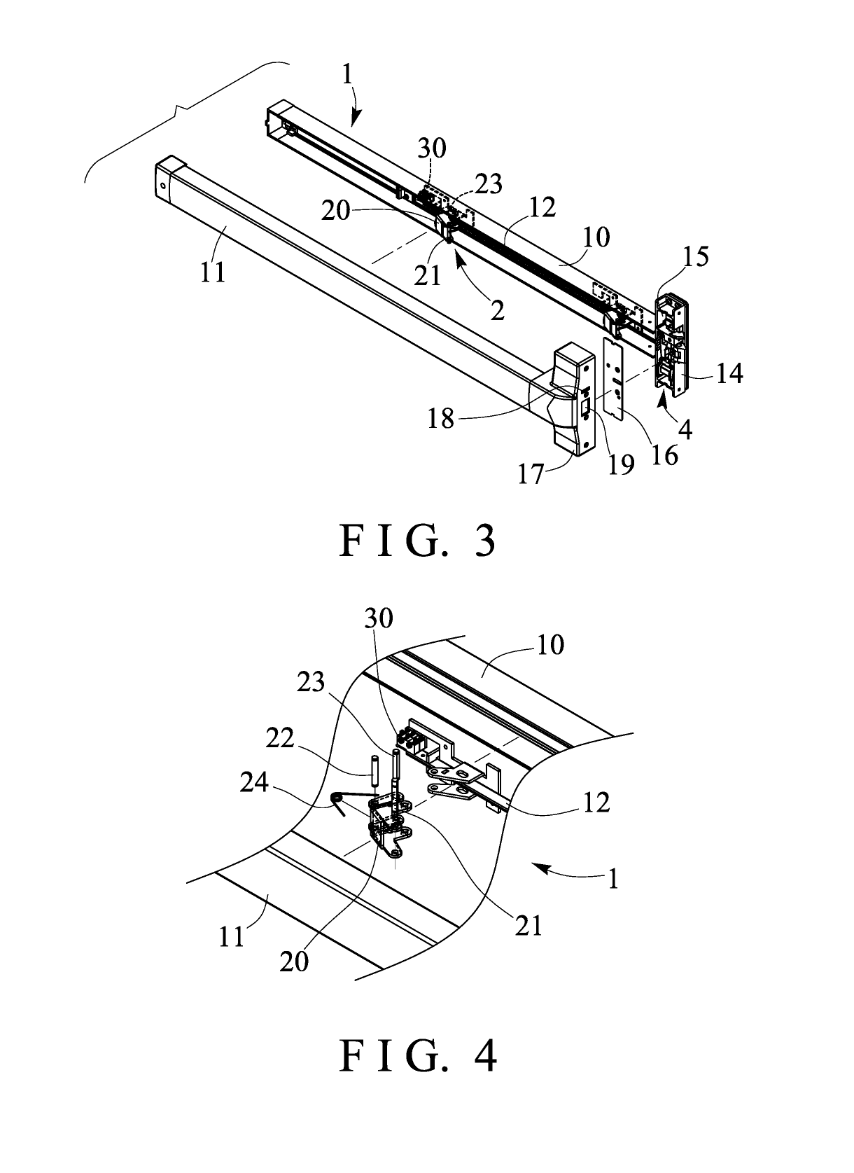

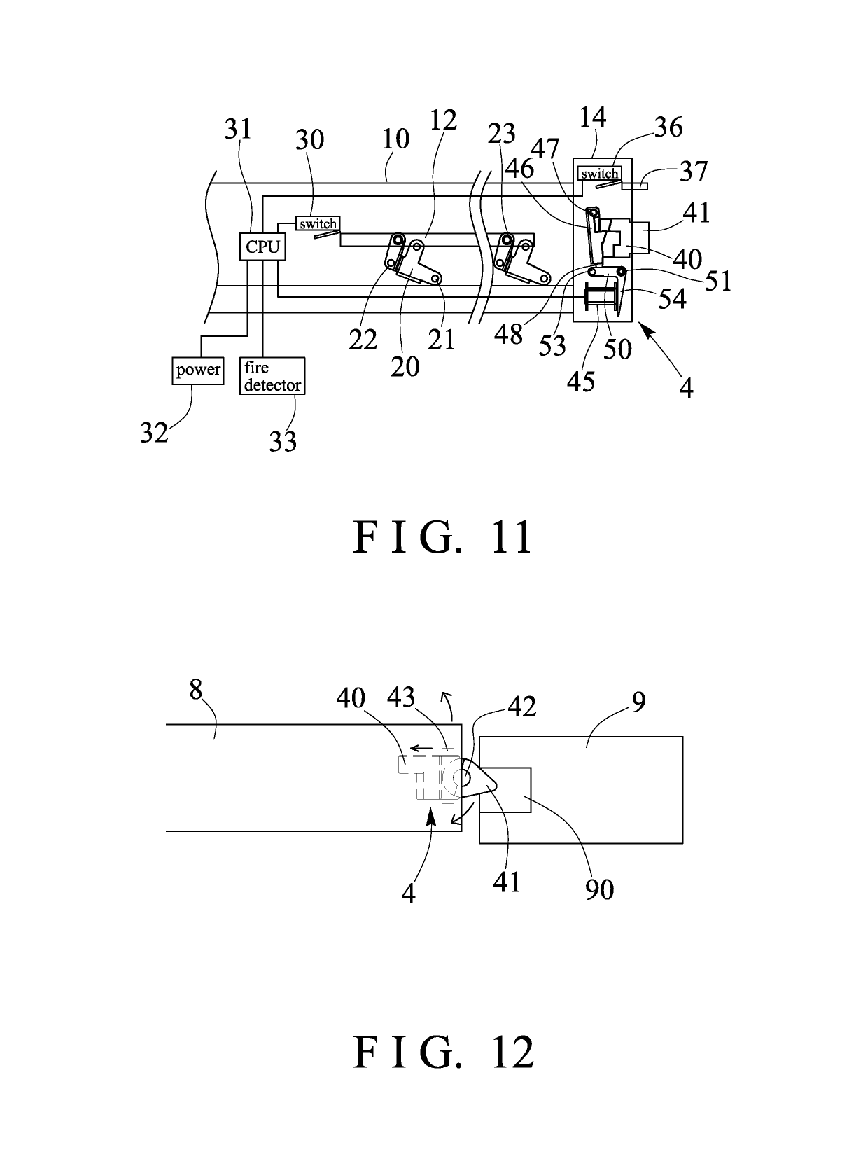

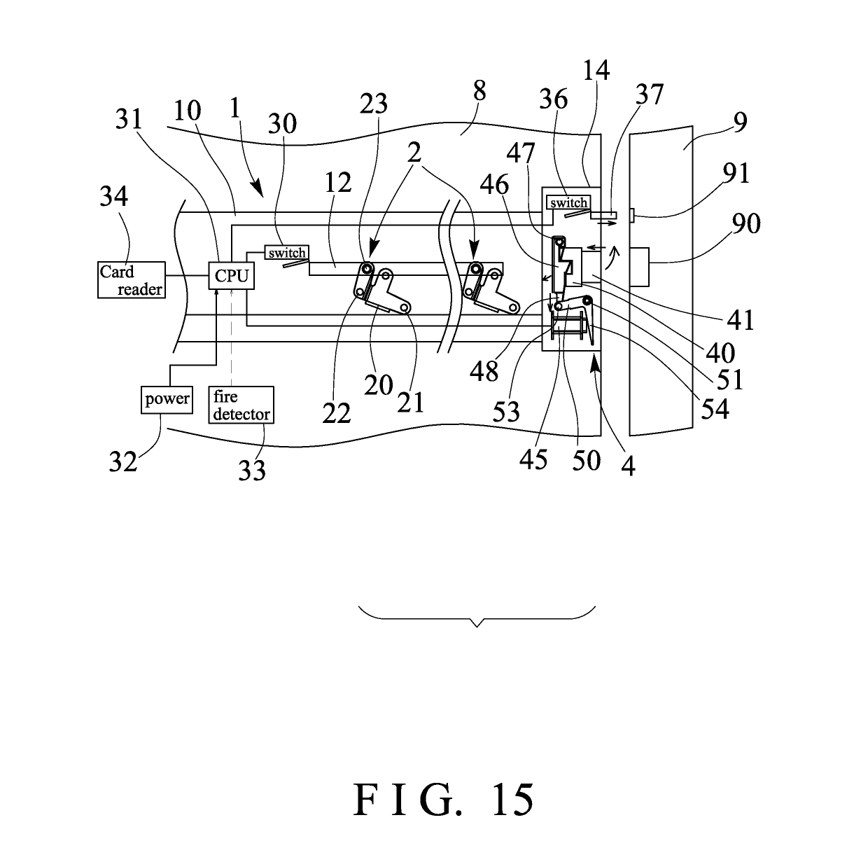

As shown in FIGS. 3 and 10, the press bar device 1 or the receptacle 10 includes a housing 14 disposed or mounted beside or on one side of the receptacle 10 and disposed and arranged or located close to or beside the door frame 9, and the housing 14 includes a compartment or chamber 15 formed therein for receiving or engaging with a lock mechanism 4 (FIGS. 1-3, 11, 13-15), and a partition or board 16 and a cap or shield 17 (FIGS. 3, 10) may further be provided and attached or mounted or secured onto the housing 14 for blocking or enclosing or sealing the chamber 15 of the housing 14 and for solidly and stably anchoring or retaining or positioning the lock mechanism 4 within the chamber 15 of the housing 14, and the shield 17 may include a slot 18 and an opening 19 formed therein and communicating with the chamber 15 of the housing 14.

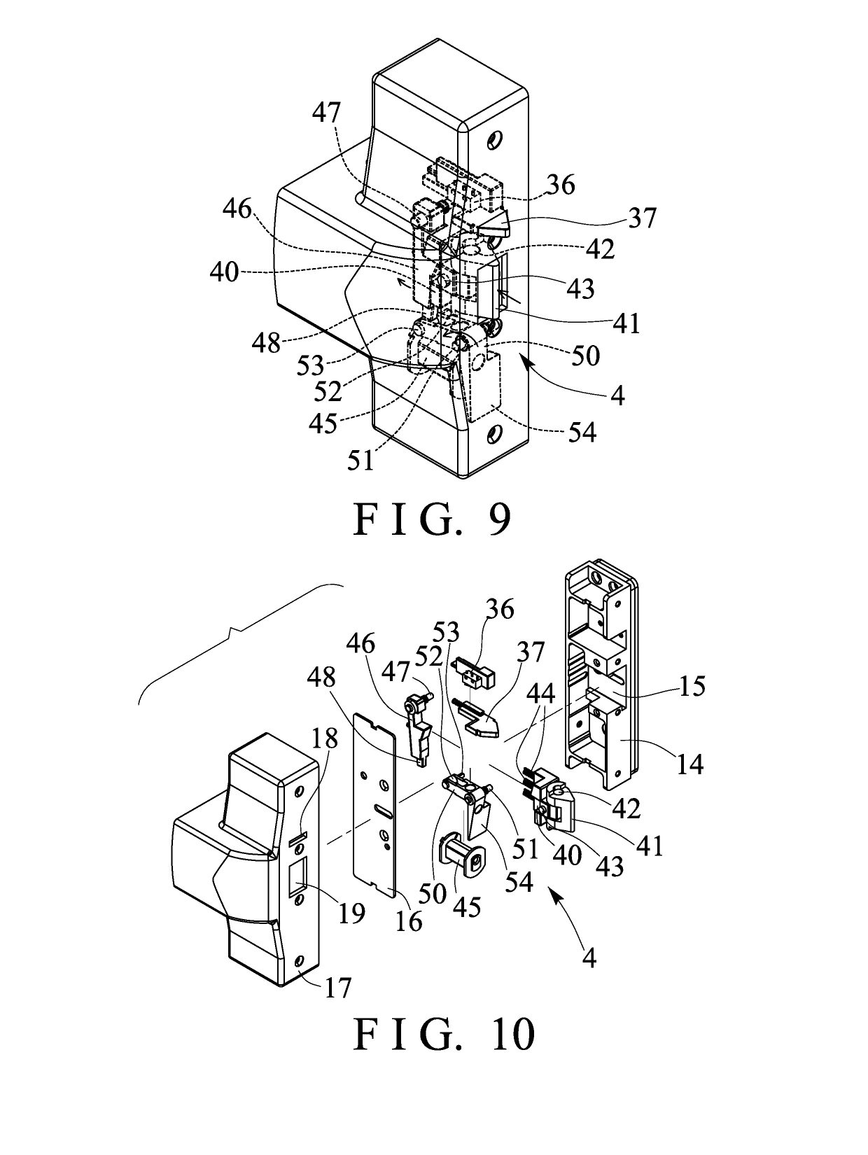

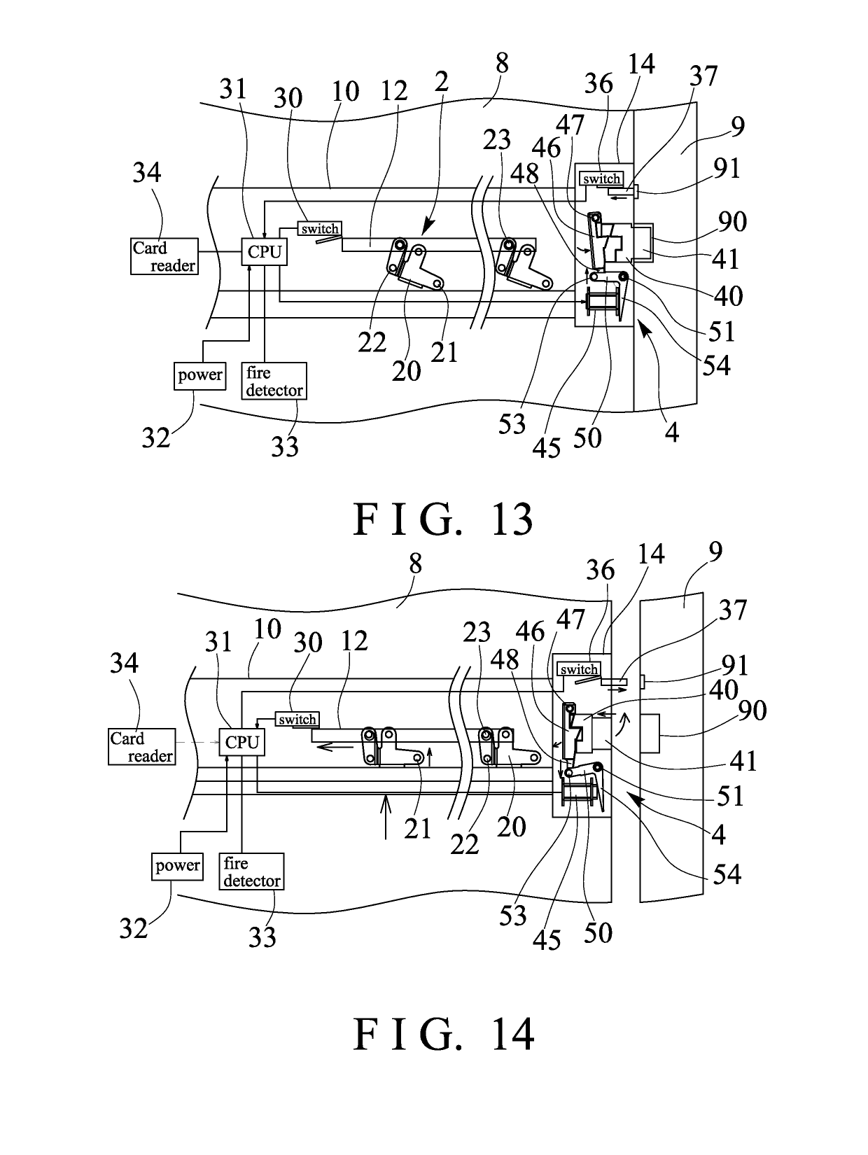

Another switch 36, such as a second or limit switch 36 is also disposed or mounted in the receptacle 10 or in the housing 14 of the receptacle 10 or in the door panel 8 and disposed and arranged or located close to or beside the door frame 9, and a safety pin 37 is slidably attached or mounted or secured to the housing 14 of the receptacle 10, and disposed and arranged or located close to or beside the switch 36, and extendible out through the slot 18 of the shield 17 or of the housing 14 (FIGS. 1, 8-9, 11, 14-15) for selectively contacting or engaging with the door frame 9 (FIGS. 2, 13) and for being selectively depressed or forced or moved by the door frame 9 to depress or actuate or operate the switch 36, and the switch 36 is electrically connected or coupled to the control device 31 for sensing or detecting whether the door panel 8 has been closed to the door frame 9 or not, and for sending or transmitting the detected signals to the control device 31.

As shown in FIGS. 1-2 and 8-15, the lock mechanism 4 includes a dead bolt 40 slidably received or engaged in the chamber 15 of the housing 14 or in the door panel 8, and the dead bolt 40 includes a tongue 41 slidable and extendible out through the opening 19 of the shield 17 or of the housing 14 or the door panel 8 (FIGS. 2, 8-9, 11-13) for selectively engaging into the door frame 9 (FIGS. 2, 13) and for selectively locking the door panel 8 to the door frame 9. The tongue 41 is pivotally or rotatably attached or mounted or coupled to the dead bolt 40 with a pivot spindle 42 for allowing the tongue 41 to be pivoted or rotated relative to the dead bolt 40 (FIG. 12), and the dead bolt 40 may further include a guide pole 43 extended laterally and outwardly therefrom and slidably engaged with the housing 14 for guiding the dead bolt 40 to move or slide relative to the housing 14.

As shown in FIG. 10, one or more spring biasing members 44 may further be provided and disposed or engaged between the housing 14 and the dead bolt 40 for biasing and forcing or moving the tongue 41 of the dead bolt 40 out through the opening 19 of the shield 17 or of the housing 14. As shown in FIGS. 1-2 and 13-15, the door frame 9 may include a cavity 90 formed therein and aligned with the tongue 41 and the dead bolt 40 for selectively receiving or engaging with the tongue 41 and the dead bolt 40, and may include a stop 91 engaged or provided therein and aligned with the safety pin 37 for selectively contacting or engaging with the safety pin 37 (FIGS. 2, 13) and for selectively forcing or moving the safety pin 37 to depress or actuate or operate the switch 36, and the switch 36 may send or transmit the detected signals to the control device 31 which may then control the fire escape door lock device.

The lock mechanism 4 further includes an electro-magnetic device 45 disposed or engaged in the chamber 15 of the housing 14 and electrically connected or coupled to the control device 31 for actuating or operating the dead bolt 40 and/or the tongue 41 to lock the door panel 8 to the door frame 9. As shown in FIGS. 8-10, a follower 46 has an upper portion pivotally or rotatably attached or mounted to the housing 14 or the door panel 8 with a pivot axle 47 and has a lower or free end portion 48, an elbow 50 has a middle portion pivotally or rotatably attached or mounted to the housing 14 or the door panel 8 with a pivot pole 51 and has a groove 52 formed therein for receiving or engaging with the lower portion 48 of the follower 46, or the elbow 50 may include a protrusion 53 extended outwardly therefrom for coupling to the lower portion 48 of the follower 46, and the elbow 50 includes a limb 54 extended downwardly therefrom and located close to or beside the electro-magnetic device 45 for being selectively forced or moved or actuated or operated by the electro-magnetic device 45 (FIGS. 1-2, 13-15).

In operation, as shown in FIG. 13, when the door panel 8 is locked to the door frame 9, the safety pin 37 is depressed or forced or moved by the door frame 9 to depress or actuate or operate the switch 36, and the switch 36 is electrically connected or coupled to the control device 31 for sending or transmitting the detected signals to the control device 31, and the control device 31 may actuate or operate the electro-magnetic device 45 to pull or attract the limb 54 of the elbow 50 toward the electro-magnetic device 45 and to force and move the follower 46 to engage with the dead bolt 40 and to force and move the dead bolt 40 and the tongue 41 into the cavity 90 of the door frame 9, and thus to lock the door panel 8 to the door frame 9. The follower 46 is disposed and located close to or beside the dead bolt 40 for selectively forcing or moving the dead bolt 40 to move out through the shield 17 or the housing 14 or the door panel 8.

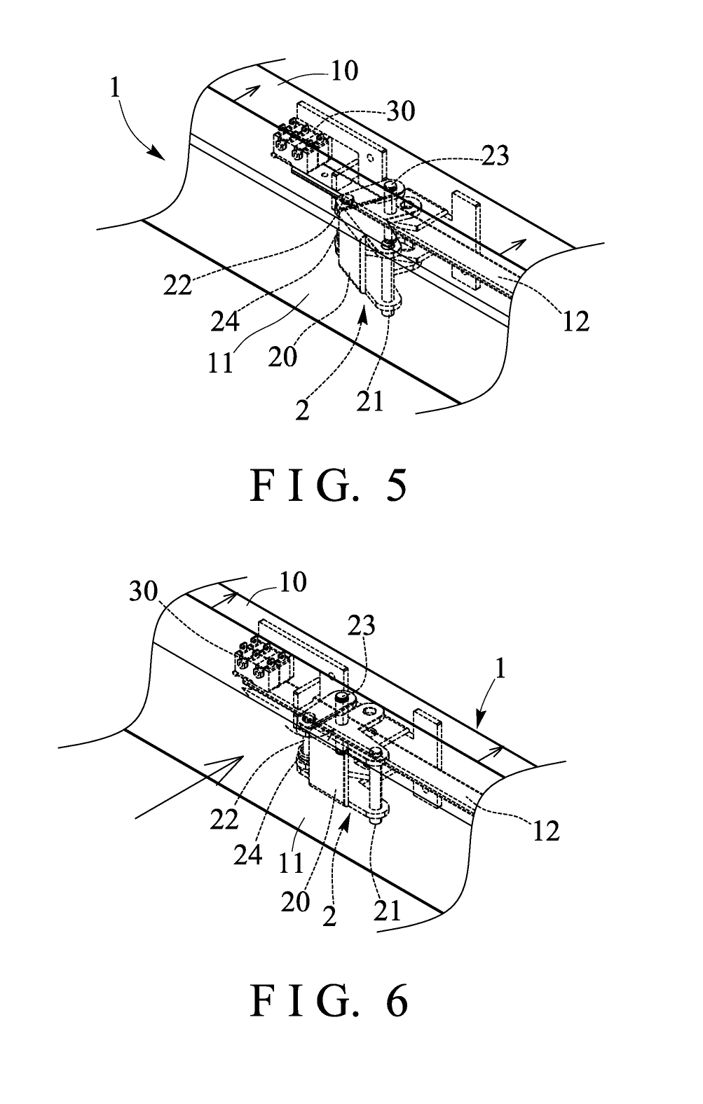

As shown in FIGS. 5-7, when the cover member 11 is depressed or moved onto or toward the receptacle 10. the beam 12 may be moved relative to the receptacle 10 by or with the brackets 20 in order to depress or actuate or operate the switch 30 and thus the control device 31, and the control device 31 may then switch off the electro-magnetic device 45 in order to release the limb 54 of the elbow 50 (FIGS. 1, 14-15), and thus for allowing the door panel 8 to be opened relative to the door frame 9. As shown in FIGS. 1-2 and 13-15, a first or outside card reader 34 is attached or mounted or secured to the outside of the door panel 8 and/or of the door frame 9 and electrically connected or coupled to the control device 31 for sending or transmitting the read signals to the control device 31 and for controlling the electro-magnetic device 45 and thus for allowing the door panel 8 to be opened or controlled relative to the door frame 9 from outside of the door panel 8 by the card holders or by the users.

Selectively or optionally or alternatively, as shown in FIGS. 1 and 2, another or inside card reader 35 may be attached or mounted or secured to the inside of the door panel 8 and/or of the door frame 9 and electrically connected or coupled to the control device 31 for sending or transmitting the read signals to the control device 31 and for controlling the electro-magnetic device 45 and thus for allowing the door panel 8 to be opened relative to the door frame 9 from inside of the door panel 8 by the card holders or by the users. At this moment, the connecting or coupling between the switch 30 and the control device 31 may be switched off, or the control device 31 will not and may not be actuated or operated by the switch 30 and the press bar device 1, and the control device 31 may be arranged to be actuated or operated only by the card reader 35, but not the press bar device 1, from inside of the door panel 8. When the flame or fire detector 33 senses or detects or receives a flame or fire and sends or transmits the detected signals to the control device 31, the control device 31 may switch off the electro-magnetic device 45 to release the limb 54 of the elbow 50 and thus for allowing the door panel 8 to be opened relative to the door frame 9 freely when in an emergency situation.

Accordingly, the fire escape door lock device in accordance with the present invention includes an electrical control device for controlling the emergency fire escape door lock device and for allowing the emergency fire escape door lock device to be selectively actuated or operated either inside or outside the fire escape door.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A fire escape door lock device comprising:
a door panel and a door frame,
a lock mechanism attached to said door panel and including a dead bolt extendible out of said door panel for selectively engaging with said door frame and for selectively locking said door panel to said door frame,
a control device disposed in said door panel, said lock mechanism being electrically connected to said control device,
a first switch disposed in said door panel and electrically connected to said control device, and
a press bar device attached to said door panel and coupled to said first switch for selectively actuating said first switch when said press bar device is depressed toward said door panel, and for selectively releasing said lock mechanism with said control device.

2. The fire escape door lock device as claimed in claim 1, wherein said press bar device includes a receptacle attached to said door panel, and a moving cover member slidably engaged onto said receptacle with a coupling device and movable toward said receptacle.

3. The fire escape door lock device as claimed in claim 2, wherein said coupling device includes a beam slidably engaged in said receptacle and movable toward said first switch for selectively actuating said first switch when said cover member is moved toward said receptacle.

4. The fire escape door lock device as claimed in claim 3, wherein said coupling device includes a bracket pivotally coupled between said receptacle and said cover member for allowing said cover member to be moved toward said receptacle, and said bracket is pivotally coupled to said beam.

5. The fire escape door lock device as claimed in claim 1, wherein said lock mechanism includes an electro-magnetic device electrically connected to said control device for actuating said dead bolt to lock said door panel to said door frame.

6. The fire escape door lock device as claimed in claim 5, wherein said lock mechanism includes a follower pivotally attached to said door panel and disposed close to said dead bolt for selectively moving said dead bolt out of said door panel, an elbow is pivotally attached to said door panel and engaged with said follower, said elbow is located close to said electro-magnetic device for being selectively actuated by said electro-magnetic device to force said follower to move said dead bolt out of said door panel.

7. The fire escape door lock device as claimed in claim 6, wherein said follower is pivotally attached to said door panel with a pivot axle, and said follower includes a free end portion, and said elbow portion includes a groove formed therein for engaging with said free end portion of said follower.

8. The fire escape door lock device as claimed in claim 1, wherein said dead bolt includes a tongue pivotally coupled to said dead bolt with a pivot spindle for allowing said tongue to be pivoted relative to said dead bolt.

9. The fire escape door lock device as claimed in claim 1, wherein said dead bolt includes a guide pole extended laterally and outwardly therefrom.

10. The fire escape door lock device as claimed in claim 1 further comprising a fire detector electrically connected to said control device for detecting a fire and for sending a detected signal to said control device and for selectively releasing said lock mechanism.

11. The fire escape door lock device as claimed in claim 1 further comprising an outside card reader electrically connected to said control device for controlling said electro-magnetic device.

12. The fire escape door lock device as claimed in claim 1 further comprising an inside card reader electrically connected to said control device for controlling said electro-magnetic device.

13. The fire escape door lock device as claimed in claim 1 further comprising an electric power source electrically connected to said control device for energizing said control device.

14. The fire escape door lock device as claimed in claim 1 further comprising a second switch electrically connected to said control device, a safety pin slidably attached to said door panel and disposed close to said second switch for selectively engaging with said door frame and for being selectively depressed and moved by said door frame to depress and actuate said second switch.

15. The fire escape door lock device as claimed in claim 1, wherein said receptacle includes a housing disposed beside said receptacle and located close to said door frame, and said housing includes a chamber formed therein for engaging with said lock mechanism.
